(19) United States
(12) Patent Application Publication
(10) Pub. No.: US 2013/0300737 A1
(43) Pub. Date: Nov. 14, 2013

(54) STEREOSCOPIC IMAGE GENERATING APPARATUS, STEREOSCOPIC IMAGE GENERATING METHOD, AND STEREOSCOPIC IMAGE GENERATING PROGRAM

(71) Applicant: Fujifilm Corporation, Tokyo (JP)

(72) Inventors: Naoyuki NISHINO, Ashigarakami-gun (JP); Yasunori OHTA, Ashigarakami-gun (JP); Takao KUWABARA, Ashigarakami-gun (JP); Yasuko YAHIRO, Ashigarakami-gun (JP); Akira HASEGAWA, San Jose, CA (US)

(73) Assignee: Fujifilm Corporation, Tokyo (JP)

(21) Appl. No.: 13/945,995

(22) Filed: Jul. 19, 2013

Related U.S. Application Data
(63) Continuation of application No. PCT/JP2012/000812, filed on Feb. 7, 2012.
(60) Provisional application No. 61/440,517, filed on Feb. 8, 2011.

(51) Int. Cl. G02B 27/22

(52) U.S. Cl. CPC G02B 27/225
USPC 345/419

(57) ABSTRACT

At least one of parallax images for left and right eyes to be fusionally displayed to perform stereopsis using binocular parallax is generated at low resolution or low sharpness of such a degree that a subject in the parallax image is observable as a stereoscopic image when an observer observes the subject in an observation mode in which the two fusionally displayed parallax images are stereoscopically viewable, and also of such a degree that the subject is recognizable as a plane image when an observer observes the subject in an observation mode in which the two fusionally displayed parallax images are not stereoscopically viewable.

### BACKGROUND OF THE INVENTION

1. Field of the Invention

The present invention relates to a technique for generating a stereoscopic image using binocular parallax.

2. Description of the Related Art

Stereoscopic display techniques using binocular parallax are known. Specifically, the stereoscopic display technique generates a parallax image for each of left and right eyes by imaging the same subject from different positions corresponding to the left and right eyes, and provides the generated parallax image for each of the eyes independently for the left and right eyes of an observer, respectively. Accordingly, the observer can recognize a subject represented in the parallax images, as a stereoscopic image having a sense of depth.

The stereoscopic display technique is being applied not only to fields of digital cameras, television or the like but also to medical fields, such as radiographic diagnosis equipment for mammography or the like and endoscopic examination equipment.

Further, apparatuses using various methods are known as stereoscopic display apparatuses based on the principle of binocular parallax. For example, methods using special glasses, such as a polarizing filter method and a frame sequential method, are known. In the polarizing filter method, left and right parallax images are output in a superimposed manner by a half mirror, and the parallax images are output after being separated for left and right eyes by glasses. In the frame sequential method, each parallax image switched at high speed is displayed. Further, only a parallax image corresponding to each of left and right eyes is provided by glasses having a liquid crystal shutter that blocks a left visual field and a right visual field alternately in such a manner to be synchronized with switching. Further, a stereoscopic display apparatus using a naked eye method is also known. The stereoscopic display apparatus using the naked eye method spatially separates left and right parallax images and display them, and only a parallax image corresponding to each of left and right eyes is provided by a parallax barrier lens, a lenticular lens or the like.

Here, when stereoscopic display is performed for plural observers, the stereoscopic display apparatus using the glasses method needs the same number of glasses as the number of the observers (for example, Japanese Unexamined Patent Publication No. 10(1998)-240212 (Patent Document 1)).

### SUMMARY OF THE INVENTION

However, glasses may not be able to be prepared for all observers in some cases. In such cases, if an observer who is not wearing glasses observes a parallax image for each eye displayed on a stereoscopic display apparatus, the parallax images are not recognized as a stereoscopic image, but recognized as a double image in which double outlines are formed by binocular parallax.

In the case of a stereoscopic display apparatus using a naked eye method, an observation position at which stereoscopic observation is possible may be limited because of the directivity of a lenticular lens or the like. Further, a region that is not observable as a stereoscopic image is generated. Therefore, in some cases, the parallax images may be recognized as a double image in a similar manner to the stereoscopic display apparatus using the glasses method.

In view of the foregoing circumstances, it is an object of the present invention to provide a stereoscopic image generating apparatus, method and program that makes it possible for both of an observer in an observation mode in which parallax images for left and right eyes are stereoscopically viewable and an observer in an observation mode in which the parallax images for left and right eyes are not stereoscopically viewable to observe each of stereoscopically displayed parallax images in an acceptable display quality.

The present invention applies findings by the applicant of the present application that stereoscopic observation is possible even if the image qualities of parallax images for left and right eyes are not the same.

Specifically, a stereoscopic image generating apparatus of the present invention is a stereoscopic image generating apparatus comprising:

a parallax image generation unit that generates a parallax image for each of left and right eyes to be fusionally displayed to perform stereopsis using binocular parallax,

wherein the parallax image generation unit generates at least one of the parallax images at low resolution or low sharpness of such a degree that a subject in the parallax image is observable as a stereoscopic image when an observer observes the subject in an observation mode in which the two fusionally displayed parallax images are stereoscopically viewable, and also of such a degree that the subject in the parallax image is recognizable as a plane image when an observer observes the subject in an observation mode in which the two fusionally displayed parallax images are not stereoscopically viewable.

A stereoscopic image generating method of the present invention is a stereoscopic image generating method that generates a parallax image for each of left and right eyes to be fusionally displayed to perform stereopsis using binocular parallax,

wherein at least one of the parallax images is generated at low resolution or low sharpness of such a degree that a subject in the parallax image is observable as a stereoscopic image when an observer observes the subject in an observation mode in which the two fusionally displayed parallax images are stereoscopically viewable, and also of such a degree that the subject in the parallax image is recognizable as a plane image when an observer observes the subject in an observation mode in which the two fusionally displayed parallax images are not stereoscopically viewable.

A stereoscopic image image generating program of the present invention causes a computer to perform the stereoscopic image generating method.

Here, fusionally displaying a parallax image for each of left and right eyes means positionally fusing the parallax images together and displaying the fused images. Therefore, a case of displaying each of the parallax images in such a manner to be positionally away from each other is excluded. Specific examples of fusional display are superimposed display of parallax images in a polarizing filter method, time division display of parallax image in a frame sequential method, spatial division display of parallax images in a naked eye method, and the like.

Further, specific examples of the observation mode in which stereopsis is not possible are conditions in which stereopsis is not possible due to environmental factors, such as a case of observation without glasses in stereoscopic display using the glasses method and a case of observation at an inappropriate position for stereoscopic display in any of the glasses method and the naked eye method, and conditions in which stereopsis is not possible due to human factors, such as individual differences or eye strain of observers.

The degree of lowering the resolution or sharpness of at least one of the parallax images may be determined based on information representing a parallax amount in each of the parallax images for left and right eyes. Here, specific examples of the information representing the parallax amount are conditions of imaging, such as the direction of imaging of each of the parallax images and a distance between a focal point, a subject and an image formation plane.

For example, as the degree of lowering resolution or lowering sharpness of one of parallax images is increased in some observation conditions, first, an observer in an observation mode in which stereopsis is possible becomes unable to observe a subject as a stereoscopic image. Then, an observer in an observation mode in which stereopsis is not possible becomes unable to recognize the subject as a plane image, because the whole image is blur. In such observation conditions, if the resolution or sharpness of at least one of the parallax images is set to a degree that a subject in the parallax image is observable as a stereoscopic image when an observer observes the subject in an observation mode in which the two fusionally displayed parallax images are stereoscopically viewable, the degree of resolution or sharpness is such a degree that the subject in the parallax image is recognizable as a plane image even if an observer observes the subject in an observation mode in which the two fusionally displayed parallax images are not stereoscopically viewable.

According to the present invention, at least one of parallax images for left and right eyes can be generated at low resolution or low sharpness of such a degree that a subject in the parallax image is observable as a stereoscopic image when an observer observes the subject in an observation mode in which the two fusionally displayed parallax images are stereoscopically viewable, and also of such a degree that the subject in the parallax image is recognizable as a plane image when an observer observes the subject in an observation mode in which the two fusionally displayed parallax images are not stereoscopically viewable. Accordingly, both of an observer in the observation mode in which parallax images for left and right eyes are stereoscopically viewable and an observer in the observation mode in which stereopsis is not possible can observe the stereoscopic image at acceptable display qualities. Hence, both of the observers in the two observation modes are coexistable.

### BRIEF DESCRIPTION OF THE DRAWINGS

FIG. 1 is a schematic diagram illustrating the configuration of a mammography and display system in which a stereoscopic image generating apparatus according to an embodiment of the present invention is installed;

FIG. 2 is a schematic cross section illustrating an arm unit of the mammography and display system;

FIG. 3 is a schematic block diagram illustrating the internal configuration of a computer of the mammography and display system according to a first embodiment of the present invention, peripheral equipment or the like;

FIG. 4 is a schematic diagram illustrating the configuration of a display system using a polarizing filter method installed in the mammography and display system;

FIG. 5 is a schematic block diagram illustrating the internal configuration of a computer of the mammography and display system according to a second embodiment of the present invention; and

FIG. 6 is a schematic block diagram illustrating the internal configuration of a computer of the mammography and display system according to a third embodiment of the present invention.

### DESCRIPTION OF THE PREFERRED EMBODIMENTS

Hereinafter, embodiments of the present invention will be described with reference to drawings. Observation of a breast by stereoscopically displaying radiographic images of the breast obtained by mammography will be used as an example. In the drawings, the size of each element or the like appropriately differs from its actual size to make them easily recognizable.

A mammography and display system in which a stereoscopic image generating apparatus according to an embodiment of the present invention has been installed includes a stereo-radiography mode and a 2D radiography mode. The stereo-radiography mode performs radiography for each of left and right eyes to perform stereopsis, and the 2D radiography mode performs ordinary radiography of a two-dimensional image. The mammography and display system displays radiographic images obtained by radiography in these radiography modes on a display (stereoscopic display unit) in which stereoscopic display is possible. In the stereo-radiography mode, one of a radiographic image for a left eye and a radiographic image for a right eye is generated at given resolution or sharpness that is lower than that of the other radiographic image. Next, the configuration and processing common to the first through third embodiments of the present invention will be described. After then, features specific to each of the embodiments will be described.

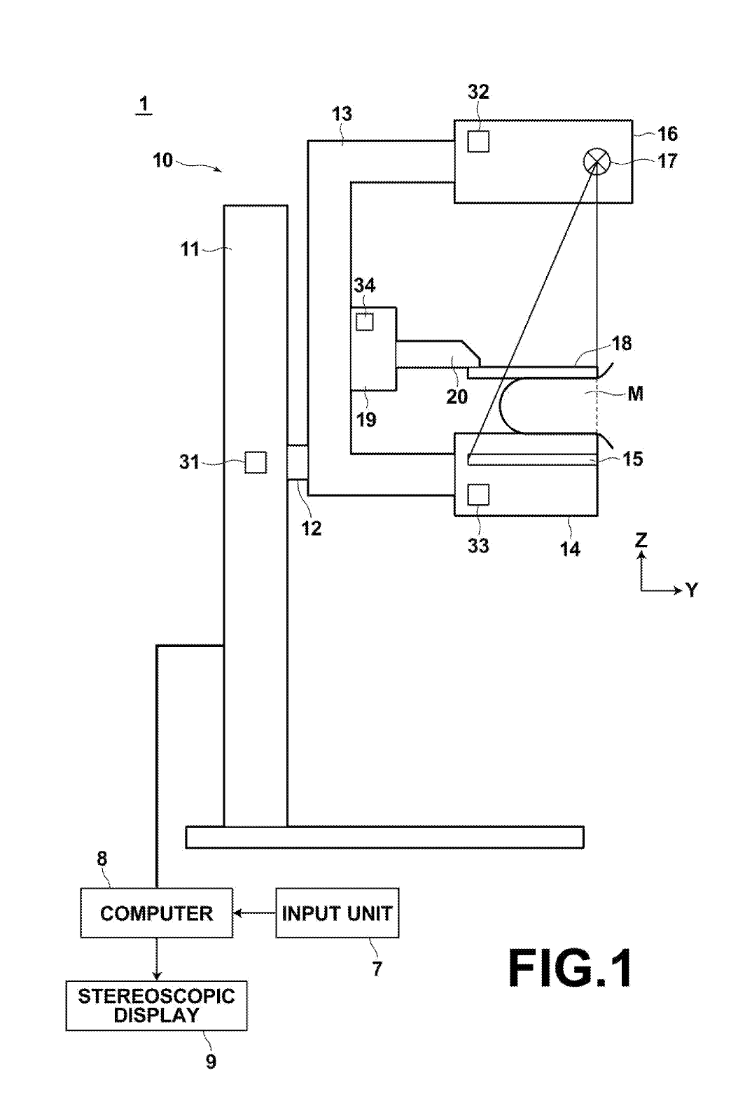

As schematically illustrated in FIG. 1, a mammography and display system 1 according to an embodiment of the present invention includes a mammography apparatus 10, a computer 8 connected to the mammography apparatus 10, a stereoscopic display 9 and an input unit 7 connected to the computer 8.

As illustrated in FIG. 1, the mammography apparatus 10 includes abase 11, a rotary shaft 12 and an arm unit 13. The rotary shaft 12 is movable in a vertical direction (Z direction) and rotatable with respect to the base 11, and the arm unit 13 is connected to the base 11 by the rotary shaft 12.

The arm unit 13 is shaped like alphabet C, and a radiography table 14 is attached to an end of the arm unit 13. Further, a radiation output unit 16 is attached to the other end of the arm unit 13 in such a manner to face the radiography table 14. The rotation and the vertical movement of the arm unit 13 are controlled by an arm controller 31 mounted in the base 11, as will be described later in detail.

A radiographic image detector 15, such as a flat panel detector, and a detector controller 33 that controls readout of charge signals from the radiographic image detector 15 are provided in the radiography table 14. Further, a charge amplifier that converts charge signals that have been read out from the radiographic image detector 15 into voltage signals, a circuit board on which a correlated double sampling circuit, an AD converter and the like are provided and the like, which are not illustrated, are set in the radiography table 14. The correlated double sampling circuit performs sampling on the voltage signals output from the charge amplifier, and the AD converter converts the voltage signals into digital signals.

The radiographic image detector 15 can repeat recording and readout of radiographic images. A so-called direct-conversion-type radiographic image detector, which generates charges by being directly irradiated with radiation, may be used. Alternatively, a so-called indirect-conversion-type radiographic image detector, which converts radiation into visible light first and then converts the visible light into charge signals, may be used. As a method for reading out radiographic images, a so-called TFT readout method, in which radiographic image signals are read out by on and off of a TFT (thin film transistor) switch, and a light readout method, in which radiographic images signals are read out by illumination with readout light, are desirable. However, the method is not limited to these methods, and other methods may be used.

The charge signals that have been read out from the radiographic image detector 15 are converted into digital image data representing a radiographic image through each processing at a charge amplifier, a correlated double sampling circuit and an AD converter, which are provided following the radiographic image detector 15.

A radiation source 17 and a radiation source controller 32 are arranged in the radiation output unit 16. The radiation source controller 32 controls the timing of outputting radiation from the radiation source 17 and radiation generation conditions (tube voltage, tube current, output time, tube current-time product, and the like) of the radiation source 17.

A compression paddle 18, a support unit 20 that supports the compression paddle 18 and a movement mechanism 19 for moving the support unit 20 in a vertical direction (Z direction) are provided at a central part of the arm unit 13. The compression paddle 18 is arranged above the radiography table 14, and compresses breast M by pressing down. The position of the compression paddle 18 and a compression thickness are controlled by a compression paddle controller 34.

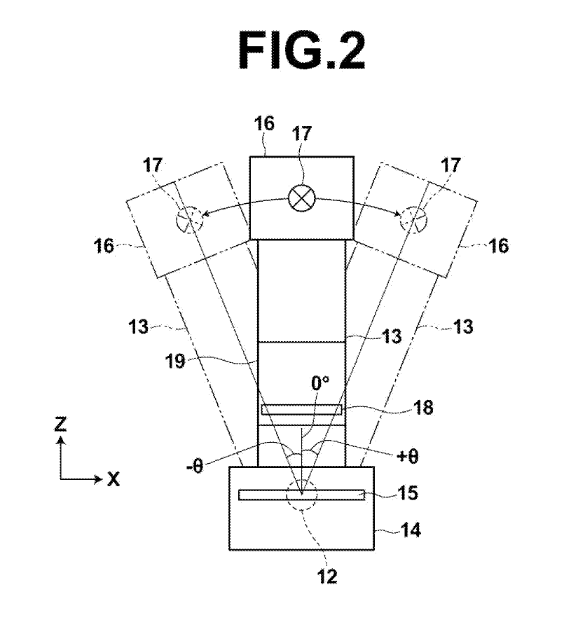

Here, the rotation mechanism of the arm unit 13 by the rotary shaft 12 will be described. FIG. 2 is a schematic diagram illustrating the front shape of the arm unit 13 viewed from the right-side direction of FIG. 1 (the positive-side direction of Y axis). As illustrated in FIG. 2, the arm unit 13 is structured in such a manner to be rotatable on the rotary axis 12, as the center of rotation. Further, the radiography table 14 is structured in such a manner to be rotatable relative to the arm unit 13. Accordingly, even if the arm unit 13 rotates, relative to the base 11, on the rotary shaft 12 as the center of rotation, the radiography table 14 is kept in a constant direction relative to the base 11. Further, the rotary shaft 12 is arranged substantially at the same height as the radiographic image detector 15. Therefore, radiation output axes of the radiation source 17 at different rotation positions from each other intersect each other in the vicinity of the radiographic image detector 15. Alternatively, the arm unit 13 may be rotated in such a manner that the radiation output axes intersect each other in the breast M, which is a subject.

Because of such a rotation mechanism, radiography is possible by outputting radiation from the radiation source 17 to the radiographic image detector 15 at various radiography angles θ (the angle of the radiation output axis with respect to the normal to the detection plane of the radiographic image detector 15). The computer 8 provides radiography angle θ for the arm controller 31. The arm unit 31 rotates, based on control by the arm controller 31, so that radiography is performed at radiography angle θ. For example, in a stereo-radiography mode, a radiographic operation is performed twice at radiography angle θ of +2° and at radiography angle θ of −2°. In a 2D radiography mode, a radiographic operation is performed only once at radiography angle θ of 0°.

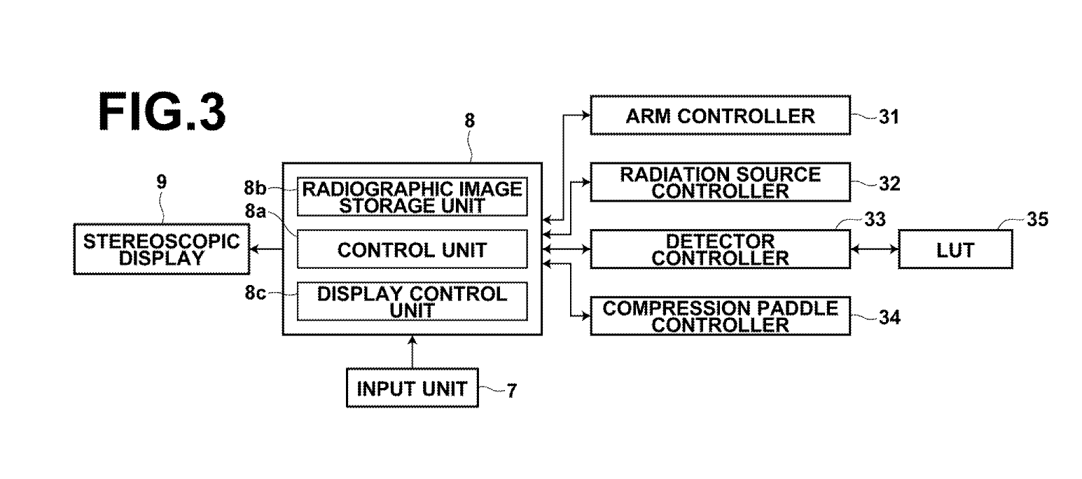

The computer 8 that controls the operation of the mammography apparatus 10 includes a central processing unit (CPU), storage devices, such as a semiconductor memory, a hard disk and SSD, and the like. These kinds of hardware and software that operates on these kinds of hardware constitute a control unit 8a, a radiographic image storage unit 8b, and a display control unit 8c, as illustrated in FIG. 3.

The control unit 8a controls the whole system by outputting predetermined control signals to various controllers 31 through 34. A specific control method will be described later in detail.

The radiographic image storage unit 8b stores digital image data representing radiographic images. In the present embodiment, the radiographic image storage unit 8b includes a storage area for image data of two radiographic images. In the stereo-radiography mode, image data of radiographic images for left and right eyes are stored to perform stereopsis. However, in the 2D radiography mode, image data of only a single radiographic image are stored.

The display control unit 8c reads out radiographic image data stored in the radiographic image storage unit 8b, and displays, based on the radiographic image data, a radiographic image of breast M on the stereoscopic display 9.

The input unit 7 includes, for example, a keyboard and a pointing device, such as a mouse. The input unit 7 receives an input, such as a radiography mode, radiography conditions and an instruction to start radiography, by a radiographer.

The stereoscopic display 9 is structured in such a manner to perform stereoscopic display using image data of radiographic images for left and right eyes stored in the radiographic image storage unit 8b of the computer 8 when radiography has been performed in a stereo-radiography mode. In the present embodiment, the stereoscopic display 9 is structured by using a polarizing filter method. In the polarizing filter method, two display screens are used, and radiographic images for left and right eyes are displayed on the two display screens, respectively. Further, a half mirror, polarizing glasses and the like are used to make an observer recognize one of the radiographic images with his/her right eye, and to make the observer recognize the other radiographic image with his/her left eye.

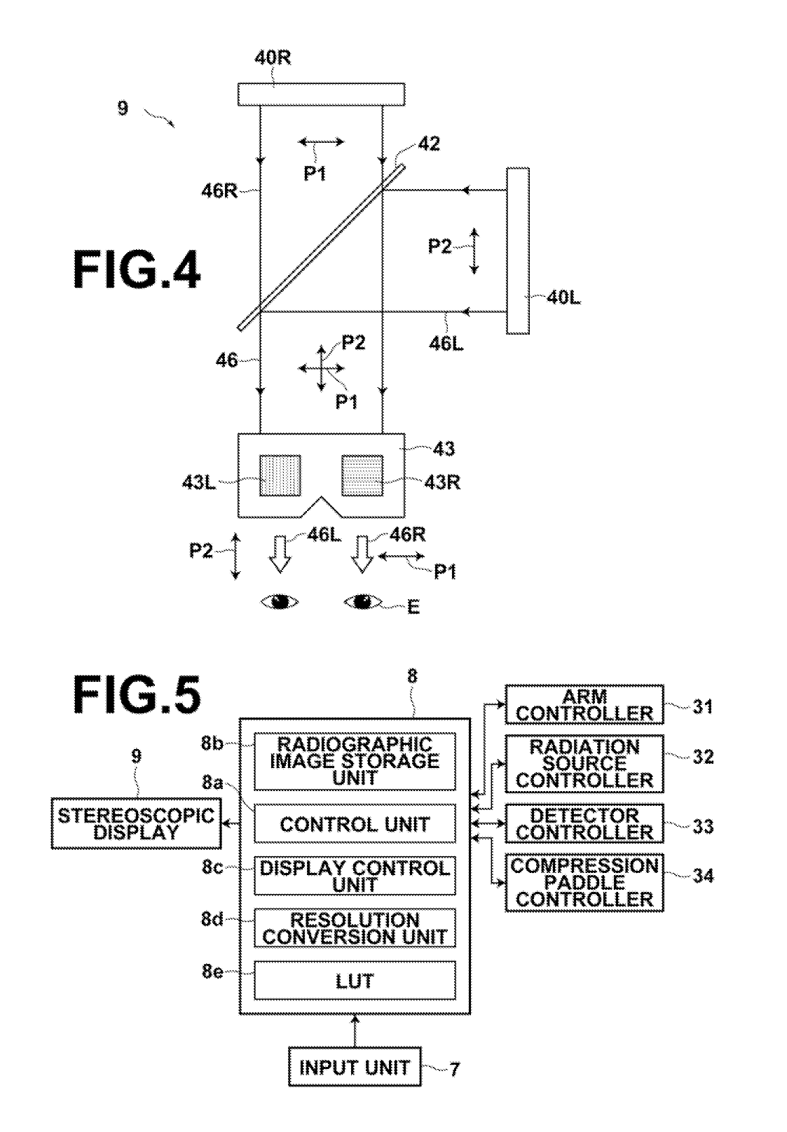

FIG. 4 is a schematic diagram illustrating the structure of the stereoscopic display 9 of the present embodiment. The stereoscopic display 9 includes a light output unit 40R for a right eye, a light output unit 40L for a left eye, a half mirror 42 and polarizing glasses 43. The light output unit 40R for a right eye outputs light signal 46R for a right eye to display an image for a right eye. The light output unit 40L for a left eye outputs light signal 46L for a left eye to display an image for a left eye.

The light output unit 40R for a right eye and the light output unit 40L for a left eye are light output units the outputs from which are controllable in such a manner to be independent from each other. The light output unit 40R for a right eye and the light output unit 40L for a left eye are arranged in such a manner that directions in which light signals are output are orthogonal to each other. Further, the light output unit 40R for a right eye and the light output unit 40L for a left eye are, for example, liquid crystal panels, and polarizing filters (not illustrated) having polarizing directions orthogonal to each other are provided on the surfaces of the liquid crystal panels. Accordingly, the light output unit 40R for a right eye outputs a light signal polarized in horizontal direction P1 (hereinafter, the left-right direction on the paper surface of FIG. 4). Meanwhile, the light output unit 40L for a left eye outputs a light signal polarized in vertical direction P2 (hereinafter, a direction perpendicular to the paper surface of FIG. 4. However, an arrow indicates a vertical direction on the paper surface for convenience.)

The half mirror 42 is provided at a position at which the light signal 46R for a right eye output from the light output unit 40R for a right eye and the light signal 46L for a left eye output from the light output unit 40L for a left eye intersect each other. Further, the half mirror 42 is structured in such a manner to pass the light signal 46R for a right eye and to reflect the light signal 46L for a left eye toward the polarizing glasses 43. Therefore, a combined signal 46 of the light signal 46R for a right eye and the light signal 46L for a left eye is formed on the half mirror 42.

The polarizing glasses 43 include a polarizing filter 43R that passes the light signal 46R for a right eye that has been polarized in horizontal direction P1 and a polarizing filter 43L that passes the light signal 46L for a left eye that has been polarized in vertical direction P2. The polarizing glasses 43 are structured in such a manner that a polarizing filter 43R faces the right eye of observer E and a polarizing filter 43L faces the left eye of the observer E when the observer E wears the polarizing glasses 43. The observer E observes the combined signal 46 through the polarizing glasses 43. At this time, the polarizing filter 43R passes only the light signal 46R for a right eye polarized in horizontal direction P1, and the polarizing filter 43L passes only the light signal 46L for a left eye polarized in vertical direction P2. Therefore, the right eye of the observer E receives only the light signal 46R for a right eye, and the left eye of the observer E receives only the light signal 46L for a left eye. Accordingly, the observer E can recognize two images having parallax with respect each other by left and right eyes, respectively, and observe breast M in the two images as a stereoscopic image.

When radiography is performed in a 2D radiography mode, the display control unit 8c of the computer 8 provides image data of the single radiographic image stored in the radiographic image storage unit 8b for both of the light output unit 40R for a right eye and the light output unit 40L for a left eye in the stereoscopic display 9. Accordingly, the same radiographic image reaches both of the eyes of the observer E through the half mirror 42 and the polarizing glasses 43. Therefore, the observer E can observe breast M as a two-dimensional image.

Next, the flow of processing in the mammography apparatus 10 will be described for a case of a stereo-radiography mode. First, as illustrated in FIG. 1, breast M is placed on the radiography table 14, and the breast H is compressed by the compression paddle 18 at predetermined pressure. At this time, the arm unit 13 is set at an initial position in which the arm unit 13 is perpendicular to the radiography table 14, in other words, at a position illustrated by a solid line in FIG. 2.

Next, an input of various radiography conditions and selection of a radiography mode are received by the input unit 7. Here, when a stereo-radiography mode is selected, the control unit 8a reads out radiography angle θ in the stereo-radiography mode that has been set in advance from an internal memory, and outputs information about the radiography angle θ to the arm controller 31. In the present embodiment, it is assumed that θ=2° has been stored in advance, as information about the radiography angle θ. However, the information about the radiography angle θ is not limited to this angle. The radiography angle θ may be about 2° to 5°.

Next, the arm controller 31 receives the information about the radiography angle θ that has been output from the control unit 8a, and outputs a control signal for rotating the arm unit 13 by +θ from the initial position based on the information about the radiography angle θ. Then, the arm unit 13 rotates by +θ based on the control signal.

Then, the control unit 8a outputs control signals to the radiation source controller 32 and the detector controller 33 so that radiation is output and radiographic image signals are read out. Then, the radiation source 17 outputs radiation based on the control signal, and the radiographic image detector 15 detects radiographic image signals obtained by performing radiography on the breast from the direction of +θ. Then, the radiographic image signals are read out from the radiographic image detector 15 by the detector controller 33. Further, AD conversion and predetermined signal processing are performed on the radiographic image signals. After then, digital image data of the radiographic images are stored in the radiographic image storage unit 8b of the computer 8.

Next, the arm controller 31 returns the arm unit 13 to the initial position once. After then, the arm controller 31 outputs a control signal for rotating the arm unit 13 by −θ from the initial position. Accordingly, the arm unit 13 rotates by −θ from the initial position.

Then, the control unit 8a outputs control signals to the radiation source controller 32 and the detector controller 33 so that radiation is output and radiographic images are read out. The radiation source 17 outputs radiation based on the control signal, and the radiographic image detector 15 detects radiographic image signals obtained by performing radiography on the breast from the direction of −θ. Then, the radiographic image signals are read out from the radiographic image detector 15 by the detector controller 33. Further, AD conversion and predetermined signal processing are performed on the radiographic image signals. After then, digital image data of the radiographic images are stored in the radiographic image storage unit 8b of the computer 8.

Accordingly, two radiographic images for left and right eyes having parallax with respect to each other are obtained.

Further, when observer E instructs stereoscopic display of a radiographic image of breast M at the input unit 7, radiographic images represented by data of two radiographic images stored in the radiographic image storage unit 8b are stereoscopically displayed, as images for left and right eyes, on the stereoscopic display 9 based on the display instruction. Here, for example, a radiographic image obtained in the first radiographic operation may be used as an image for a right eye of a stereoscopic image, and a radiographic image obtained in the second radiographic operation may be used as an image for a left eye of the stereoscopic image.

Next, a part specific to each embodiment will be described. In the first embodiment, a structure composed of the detector controller 33, a LUT 35 and the radiographic image detector 15 corresponds to the parallax image generation unit of the present invention. In the second embodiment, a structure composed of a resolution conversion unit 8d, a LUT 8e and the radiographic image detector 15 corresponds to the parallax image generation unit of the present invention. In the third embodiment, a structure composed of an unsharpening unit 8f, the LUT 8e and the radiographic image detector 15 corresponds to the parallax image generation unit of the present invention.

In the first embodiment of the present invention, when operations are performed in a stereo-radiography mode, the detector controller 33 controls in such a manner that readout is performed at low resolution in the first radiographic operation at radiography angle of +θ. The radiographic image detector 15 outputs signals after two-dimensionally thinning, at predetermined intervals, signals of respective pixels. However, in the second radiographic operation at radiography angle of −θ, the detector controller 33 controls in such a manner that readout is performed at high resolution, and the radiographic image detector 15 outputs all signals of respective pixels.

Here, when readout is performed at low resolution in the first radiographic operation, the detector controller 33 accesses the LUT 35, and obtains an interval of thinning of signals based on radiography conditions. The LUT 35 is a look-up table that defines an interval of thinning of signals for each of at least one radiography condition, such as radiography angle θ, a distance between the radiation source 17 and the radiographic image detector 15, a distance between the radiation source 17 and breast M, a distance between breast M and the radiographic image detector 15, and a compression thickness of breast M. The interval of thinning has been experimentally or empirically obtained in advance for each radiography condition so that the degree of resolution is such a degree that breast M, which is a subject, is observable as a stereoscopic image when observer E who is wearing polarizing glasses 43 observes radiographic images that have been obtained in stereo-radiography mode and stereoscopically displayed on the stereoscopic display 9, and also that the breast M is recognizable as a plane image even if observer E who is not wearing the polarizing glasses 43 observes the images. Additionally, the interval of thinning may be determined in such a manner that breast M is recognizable as a plane image when observer E observes the images at an observation position at which stereoscopic observation is difficult even if he/she wears the polarizing glasses 43. Here, when radiography conditions are representable as numerical values, a function that receives radiography conditions represented as numerical values and that outputs an interval of thinning may be used instead of the LUT 35.

As described above, in the first embodiment of the present invention, when signals are read out from the radiographic image detector 15, the detector controller 33 determines an interval of thinning, by accessing the LUT 35, so that the interval of thinning is such a degree that breast M, which is a subject, is observable as a stereoscopic image when observer E observes radiographic images for left and right eyes that are stereoscopically displayed on the stereoscopic display 9 in an observation mode in which stereopsis is possible, and also that the breast M, which is the subject, is recognizable as a plane image even if observer E observes the radiographic images in an observation mode in which stereopsis is not possible. Further, radiographic image signals for a left eye or radiographic image signals for a right eye are read out at the interval of thinning. Here, as in the findings by the applicant of the present application, stereoscopic observation is possible even if two radiographic images are generated at different resolution from each other, as described above. Therefore, observation of radiographic images at acceptable display qualities is possible by both of an observer who is wearing polarizing glasses 43 in an observation mode in which stereopsis is possible and an observer in an observation mode in which stereopsis is not possible because the observer is not wearing the polarizing glasses 43 or the observer is located at an observation position that is inappropriate for stereopsis even if the observer wears the polarizing glasses 43, or the like. Hence, both of the observers in the observation modes are coexistable.

In the present embodiment, readout is performed at low resolution for the first radiographic operation, and readout is performed at high resolution for the second radiographic operation. Accordingly, a time period of readout of signals for the first radiographic operation is reduced, but a time period of readout of signals for the second radiographic operation is longer than that of the first radiographic operation. Here, compression of breast M of a patient is releasable in the step of reading out signals for the second radiographic operation. Therefore, a subject to be examined is restricted only from the time of the first radiographic operation to the time of starting readout of signals for the second radiographic operation. Since readout at low resolution is performed before readout at high resolution is performed, it is possible to reduce a time period in which the subject to be examined is restricted, compared with a case in which readout of signals for both of the radiographic operations is performed at high resolution. Hence, a burden of mammography on the subject to be examined is reduced. Especially, in mammography, compression of a breast often gives a heavy burden to the subject to be examined. Therefore, the reduction in restriction time has a remarkable effect in reducing psychological burdens.

Further, since one of the radiographic image for a left eye and the radiographic image for a right eye is read out at lower resolution than that of the other one, it is possible to reduce the data amount of all the images necessary to perform stereopsis, because the data amount of the image read out at low resolution is small. Further, it is possible to ease the problems of an increased load on storages for storing radiographic image data and a drop in the efficiency of transmission of image data between devices.

In the above embodiment, stereo-radiography was performed at the radiography angle of ±2°. Alternatively, radiography may be performed in such a manner that one of radiography angles is 0° and the other radiography angle is, for example, 4° or −4°. Further, the radiographic image obtained in radiography at radiography angle of 0° may be used as an image for both of stereoscopic display and two-dimensional display that is used for ordinary image reading and diagnosis. Accordingly, it is not necessary to radiograph/obtain an image for two-dimensional display besides the image for stereoscopic display. Therefore, it is possible to reduce a burden on the subject to be examined by reducing the restriction time of the subject to be examined and by reducing the exposure dose of radiation. Compared with a case in which one of radiographic images obtained by radiographic operations at radiography angles of ±2° is used as an image for image reading and diagnosis, the image at radiography angle of 0°, in which the influence of vignetting by grids or the like is small, can be used for image reading and diagnosis, and that improves the accuracy of image reading and diagnosis. Further, when one of the radiography angles is 0°, it is desirable that the radiographic image obtained at the radiography angle of 0° is read out at high resolution to obtain higher definition radiographic images for image reading and diagnosis.

The second embodiment of the present invention does not change resolution when signals are read out from the radiographic image detector 15. The resolution is converted by performing image processing on image data of radiographic images on which signal readout and conversion have been performed.

FIG. 5 is a schematic block diagram illustrating the internal structure of the computer 8 in the mammography and display system according to the second embodiment of the present invention. As illustrated in FIG. 5, in the second embodiment of the present invention, the resolution conversion unit 8d is further added in the computer 8, and the LUT 8e is installed in the computer 8, instead of the LUT 35 accessed by the detection controller 33. The resolution conversion unit 8d is realized by executing a program installed from a recording medium, such as a CD-ROM. The program may be installed after being downloaded from a storage device of a server connected through a network, such as the Internet.

The resolution conversion unit 8d receives digital image data representing radiographic images, and performs known resolution conversion processing, and outputs image data after conversion to low resolution. Here, the degree of lowering resolution in the resolution conversion processing is obtained in an operation of accessing the LUT Be by the resolution conversion unit 8d. The LUT 8e is a look-up table that defines the degree of lowering resolution for each radiography condition, such as radiography angle θ, a distance between the radiation source 17 and the radiographic image detector 15, a distance between the radiation source 17 and breast M, a distance between breast M and the radiographic image detector 15, and a compression thickness of breast M. The specific degree of lowering resolution has been experimentally or empirically obtained in advance for each radiography condition so that the degree of lowering resolution is such a degree that breast M, which is a subject, is observable as a stereoscopic image when observer E who is wearing polarizing glasses 43 observes radiographic images that have been obtained in stereo-radiography mode and stereoscopically displayed on the stereoscopic display 9, and also that the breast M is recognizable as a plane image even if observer E who is not wearing the polarizing glasses 43 observes the images.

In the second embodiment of the present invention, when radiography is performed in a stereo-radiography mode, the detector controller 33 controls in such a manner that readout is performed at high resolution without thinning in both of the first radiographic operation and the second radiographic operation. Radiographic image signals that have been read out are converted to radiographic image data through each processing at a charge amplifier, a correlated double sampling circuit, and an AD conversion circuit. After then, the resolution conversion unit 8d accesses the LUT 8e, and determines the degree of lowering resolution, and performs resolution conversion on radiographic image data obtained in one of the first radiographic operation and the second radiographic operation. The radiographic image storage unit 8b stores image data after lowering resolution for the radiographic image on which resolution conversion has been performed. Other features are similar to the first embodiment.

As described above, in the second embodiment, the resolution of one of the two radiographic images is lowered by image processing at the resolution conversion unit 8d. Therefore, effects similar to those of the first embodiment are obtainable.

In the second embodiment, the resolution conversion unit 8d lowers resolution before radiographic image data are stored in the radiographic image storage unit 8b. As a modified example, the resolution of one of the two radiographic images may be converted when radiographic images are displayed on the stereoscopic display 9. Specifically, two radiographic image data sets that have been read out at high resolution are stored in the radiographic image storage unit 8b. When observer E inputs an instruction for stereoscopic display of breast M at the input unit 7, the resolution conversion unit 8d lowers resolution of one of the two radiographic images based on the instruction for display. The display control unit 8c makes the stereoscopic display 9 perform stereoscopic display based on the radiographic image data the resolution of which has been lowered and the other radiographic image data on which resolution conversion has not been performed. Therefore, in this modified example, it is possible to store, at high resolution, both of radiographic image data obtained in the first radiographic operation and radiographic image data obtained in the second radiographic operation in the radiographic image storage unit 8b. Hence, the utility value of radiographic images becomes higher.

For example, when stereoscopic display is performed, selection as to whether processing for lowering resolution by the resolution conversion unit 8d is performed may be received at the input unit 7, and processing by the resolution conversion unit 8d may be switched based on the selection. Accordingly, it is possible to select so that the resolution conversion unit 8d performs processing for lowering resolution when the number of polarizing glasses 43 is less the number of observer or observers E, or so that processing by the resolution conversion unit 8d is skipped when the number of polarizing glasses 43 is greater than or equal to the number of observer or observers E. Therefore, flexible stereoscopic display based on the observation mode of observer E is realized.

The third embodiment of the present invention is based on the findings by the applicant of the present application that stereoscopic observation is possible even if the degrees of sharpness of two radiographic images are different from each other. Image processing for unsharpening one of the two radiographic images is performed, instead of processing for lowering resolution.

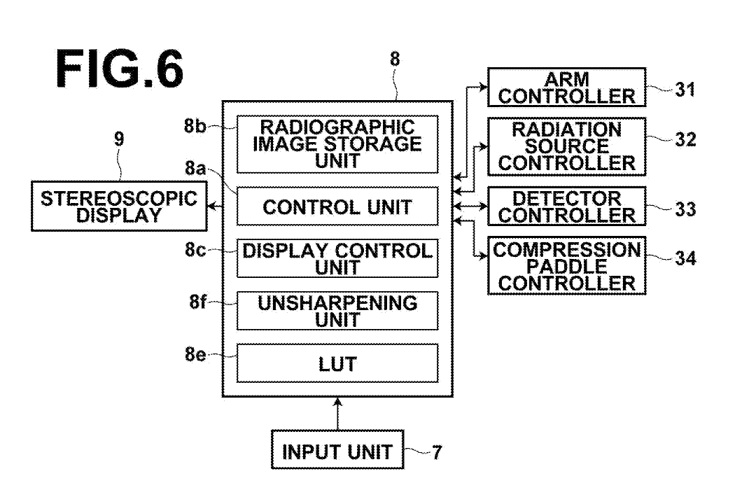

FIG. 6 is a schematic block diagram illustrating the internal structure of the computer 8 in the mammography and display system according to the third embodiment of the present invention. As illustrated in FIG. 6, in the third embodiment of the present invention, the resolution conversion unit 8d in the second embodiment is replaced by the unsharpening unit 8f. The unsharpening unit 8f is realized by executing a program installed in a similar manner to the resolution conversion unit 8d in the second embodiment. Further, the timing of processing by the unsharpening unit 8f is similar to that of the resolution conversion unit 8d in the second embodiment or its modified example.

The unsharpening unit 8f receives digital image data representing radiographic images, and performs known unsharpening processing, and outputs unsharpened image data. Here, the degree of unsharpening is obtained in an operation of accessing the LUT 8e by the unsharpening unit 8f. The LUT 8e is a look-up table that defines the degree of unsharpening for each radiography condition, such as radiography angle θ, a distance between the radiation source 17 and the radiographic image detector 15, a distance between the radiation source 17 and breast M, a distance between breast M and the radiographic image detector 15, and a compression thickness of breast M. The specific degree of unsharpening has been experimentally or empirically obtained in advance for each radiography condition so that the degree of sharpness is such a degree that breast M, which is a subject, is observable as a stereoscopic image when observer E who is wearing polarizing glasses 43 observes radiographic images that have been obtained in stereo-radiography mode and stereoscopically displayed on the stereoscopic display 9, and also that the breast M is recognizable as a plane image even if observer E who is not wearing the polarizing glasses 43 observes the images.

As described above, in the third embodiment of the present invention, effects similar to those of the first and second embodiments are obtainable by unsharpening one of the two radiographic images in the image processing at the unsharpening unit 8f.

Further, in each of the embodiments, a switch for switching whether polarization is performed may be provided in the polarizing glasses 43. Accordingly, each observer who is wearing polarizing glasses 43 can switch whether observation in stereoscopic display is performed based on his/her stereoscopic observation conditions (for example, an observation position, individual differences as to whether stereopsis is possible, the degree of eye strain or the like). In that case, even if the polarizing glasses 43 are switched to a setting in which observation in stereoscopic display is not performed, since one of the two radiographic images is a low resolution image or a low sharpness image, it is possible to observe breast M, which is a subject, as a plane image at acceptable display qualities.

The embodiments and the modified example are only examples, and none of all the descriptions is used to limit the technical scope of the present invention. Further, with respect to the system configuration, hardware configuration, flow of processing, module configuration, user interface, specific processing content, and the like in the embodiments, various modifications without departing from the gist of the present invention are included in the technical scope of the present invention.

For example, in the embodiments, a human breast is a subject. Alternatively, the subject may be a different region, such as a head and a chest (heart and lung). Further, an endoscope image may be used. Alternatively, a photographic image obtained by a digital camera, or a video image for TV may be used.

The stereoscopic display may use a frame sequential method, a naked-eye method, and the like.

Further, in each of the embodiments, two radiographic images for stereoscopic display are imaged by changing the direction of outputting radiation in X-Z plane illustrated in FIG. 2. Alternatively, plural radiographic images may be imaged by changing the direction of outputting radiation to other directions. Specifically, plural radiographic images may be imaged by changing the direction of outputting radiation, for example, in Y-Z plane illustrated in FIG. 2 (a plane perpendicular to the paper surface of FIG. 2)

Further, in each of the embodiments, processing for lowering resolution or unsharpening is performed on only one of the radiographic image for a left eye and the radiographic image for a right eye. Alternatively, processing for lowering resolution or unsharpening may be performed on both of the radiographic images. In that case, the degree of lowering resolution or unsharpening may be the same for both of the images, or different from each other.

What is claimed is:

1. A stereoscopic image generating apparatus comprising:
a parallax image generation unit that generates a parallax image for each of left and right eyes to be fusionally displayed to perform stereopsis using binocular parallax,
wherein the parallax image generation unit generates at least one of the parallax images at low resolution of such a degree that a subject in the parallax image is observable as a stereoscopic image when an observer observes the subject in an observation mode in which the two fusionally displayed parallax images are stereoscopically viewable, and also of such a degree that the subject in the parallax image is recognizable as a plane image when an observer observes the subject in an observation mode in which the two fusionally displayed parallax images are not stereoscopically viewable.

2. A stereoscopic image generating apparatus comprising:
a parallax image generation unit that generates a parallax image for each of left and right eyes to be fusionally displayed to perform stereopsis using binocular parallax,
wherein the parallax image generation unit generates at least one of the parallax images at low sharpness of such a degree that a subject in the parallax image is observable as a stereoscopic image when an observer observes the subject in an observation mode in which the two fusionally displayed parallax images are stereoscopically viewable, and also of such a degree that the subject in the parallax image is recognizable as a plane image when an observer observes the subject in an observation mode in which the two fusionally displayed parallax images are not stereoscopically viewable.

3. The stereoscopic image generating apparatus, as defined in claim 1, wherein the parallax image generation unit determines the degree based on information representing a parallax amount in each of the parallax images.

4. The stereoscopic image generating apparatus, as defined in claim 2, wherein the parallax image generation unit determines the degree based on information representing a parallax amount in each of the parallax images.

5. The stereoscopic image generating apparatus, as defined in claim 3, wherein the information representing the parallax amount is the direction of imaging of each of the parallax images and/or a distance between any two of a focal point, a subject and an image formation plane at the time of imaging of each of the parallax images.

6. The stereoscopic image generating apparatus, as defined in claim 4, wherein the information representing the parallax amount is the direction of imaging of each of the parallax images and/or a distance between any two of a focal point, a subject and an image formation plane at the time of imaging of each of the parallax images.

7. The stereoscopic image generating apparatus, as defined in claim 1, further comprising a stereoscopic display unit that performs stereoscopic display using each of the parallax images.

8. The stereoscopic image generating apparatus, as defined in claim 2, further comprising a stereoscopic display unit that performs stereoscopic display using each of the parallax images.

9. The stereoscopic image generating apparatus, as defined in claim 3, further comprising a stereoscopic display unit that performs stereoscopic display using each of the parallax images.

10. The stereoscopic image generating apparatus, as defined in claim 4, further comprising a stereoscopic display unit that performs stereoscopic display using each of the parallax images.

11. The stereoscopic image generating apparatus, as defined in claim 5, further comprising a stereoscopic display unit that performs stereoscopic display using each of the parallax images.

12. The stereoscopic image generating apparatus, as defined in claim 6, further comprising a stereoscopic display unit that performs stereoscopic display using each of the parallax images.

13. A stereoscopic image generating method that generates a parallax image for each of left and right eyes to be fusionally displayed to perform stereopsis using binocular parallax,
wherein at least one of the parallax images is generated at low resolution of such a degree that a subject in the parallax image is observable as a stereoscopic image when an observer observes the subject in an observation mode in which the two fusionally displayed parallax images are stereoscopically viewable, and also of such a degree that the subject in the parallax image is recognizable as a plane image when an observer observes the subject in an observation mode in which the two fusionally displayed parallax images are not stereoscopically viewable.

14. A stereoscopic image generating method that generates a parallax image for each of left and right eyes to be fusionally displayed to perform stereopsis using binocular parallax,
wherein at least one of the parallax images is generated at low sharpness of such a degree that a subject in the parallax image is observable as a stereoscopic image when an observer observes the subject in an observation mode in which the two fusionally displayed parallax images are stereoscopically viewable, and also of such a degree that the subject in the parallax image is recognizable as a plane image when an observer observes the subject in an observation mode in which the two fusionally displayed parallax images are not stereoscopically viewable.

15. A non-transitory computer-readable recording medium storing therein a stereoscopic image generating program that causes a computer to generate a parallax image for each of left and right eyes to be fusionally displayed to perform stereopsis using binocular parallax,
wherein at least one of the parallax images is generated by the computer at low resolution of such a degree that a subject in the parallax image is observable as a stereoscopic image when an observer observes the subject in an observation mode in which the two fusionally displayed parallax images are stereoscopically viewable, and also of such a degree that the subject in the parallax image is recognizable as a plane image when an observer observes the subject in an observation mode in which the two fusionally displayed parallax images are not stereoscopically viewable.

16. A non-transitory computer-readable recording medium storing therein a stereoscopic image generating program that causes a computer to generate a parallax image for each of left and right eyes to be fusionally displayed to perform stereopsis using binocular parallax,
wherein at least one of the parallax images is generated by the computer at low sharpness of such a degree that a subject in the parallax image is observable as a stereoscopic image when an observer observes the subject in an observation mode in which the two fusionally displayed parallax images are stereoscopically viewable, and also of such a degree that the subject in the parallax image is recognizable as a plane image when an observer observes the subject in an observation mode in which the two fusionally displayed parallax images are not stereoscopically viewable.
